(19) United States
(12) Patent Application Publication
(10) Pub. No.: US 2008/0091718 A1
(43) Pub. Date: Apr. 17, 2008

(54) Coordinating digital video recorder ('DVR') recording with a user's electronic calendar

(76) Inventors: Eric L. Barsness, Pine Island, MN (US); John M. Santosuosso, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/548,777

(22) Filed: Oct. 12, 2006

(51) Int. Cl. G06F 17/00

(52) U.S. Cl. 707/104.1

(57) ABSTRACT

Coordinating digital video recorder (‘DVR’) recording with a user's electronic calendar, including establishing, by the DVR on behalf of the user, a user profile on the DVR, where the user profile includes a network location for the user's electronic calendar, the user's electronic calendar is installed upon a remote device, and the remote device is connected for data communications through a data communications network to the DVR. Embodiment also include the DVR's tracking information describing at least one show watched by the user and making an electronic calendar entry on the user's electronic calendar in dependence upon the information describing the show.

### BACKGROUND OF THE INVENTION

1. Field of the Invention

The field of the invention is data processing, or, more specifically, methods, systems, and products for coordinating digital video recorder (‘DVR’) recording with a user's electronic calendar.

2. Description Of Related Art

A digital video recorder (‘DVR’), sometimes referred to as a personal video recorder or ‘PVR,’ is an automated device that records video without videotape to a hard drive-based digital storage medium. The term ‘DVR’ as it is used in this specification includes stand-alone set-top boxes and DVR application software for personal computers which enables video capture and playback to and from disk. Examples of DVRs implemented as stand-alone set-top boxes include TiVo™ DVRs and ReplayTV™ DVRs. Examples of DVR application software for personal computers include SageTV™, Showshifter™, and MediaPortal™.

DVRs have steadily developed additional abilities, such as recording onto DVDs, commercial skip, sharing of recordings over the Internet, and programming and remote control facilities using PDAs, networked PCs, or Web browsers. Such features make time shifting shows much more convenient—and also allow for other techniques not available with regular television, such as pausing live TV, instant replay of interesting scenes, and skipping advertising. Most DVRs use the MPEG format for encoding analog video signals in a digital format.

The time shifting provided by DVRs free users to view shows at a time chosen by the user rather than the time chosen by the show's regular programming. As a practical matter, however, many users are creatures of habit who tend to watch certain shows or certain types of shows at certain times. Even though a user may watch a show recorded on the DVR when the user wants to, it is often predictable when that will be. There may be key favorite programs, for example, that are watched the night they are recorded—or as quickly as the user can get around to watching them. Some shows are set to keep only one copy, such as the most recent national evening news. These programs are set up this way in anticipation of daily viewing. In other cases there are still shows that the user wishes to watch live, especially sporting events, although the user still uses the DVR so that the user can replay certain events or pause the DVR to get more snacks.

Many of these users with regular DVR viewing patterns also schedule their daily activities, to some extent at least, by use of electronic calendars such as, for example, Microsoft Outlook™ or IBM's Lotus Organizer™. It would be useful if there were some automated method of scheduling predictable DVR viewing activities through users' electronic calendars, but in current art there is no such method.

### SUMMARY OF THE INVENTION

Methods, apparatus, and computer program products for coordinating digital video recorder (‘DVR’) recording with a user's electronic calendar are disclosed that include establishing, by the DVR on behalf of the user, a user profile on the DVR, where the user profile includes a network location for the user's electronic calendar, the user's electronic calendar is installed upon a remote device, and the remote device is connected for data communications through a data communications network to the DVR. Embodiment also include the DVR's tracking information describing at least one show watched by the user and making an electronic calendar entry on the user's electronic calendar in dependence upon the information describing the show.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary apparatus for coordinating DVR recording with a user's electronic calendar according to embodiments of the present invention.

FIG. 2 sets forth a block diagram of automated computing machinery comprising an exemplary computer useful in coordinating DVR recording with a user's electronic calendar according to embodiments of the present invention.

FIG. 3 sets forth a flow chart illustrating an exemplary method of coordinating DVR recording with a user's electronic calendar according to embodiments of the present invention.

FIG. 4 sets forth a flow chart illustrating a further exemplary method for coordinating DVR recording with a user's electronic calendar according to embodiments of the present invention.

FIG. 5 sets forth a flow chart illustrating a further exemplary method for coordinating DVR recording with a user's electronic calendar according to embodiments of the present invention.

### DETAILED DESCRIPTION OF EXEMPLARY EMBODIMENTS

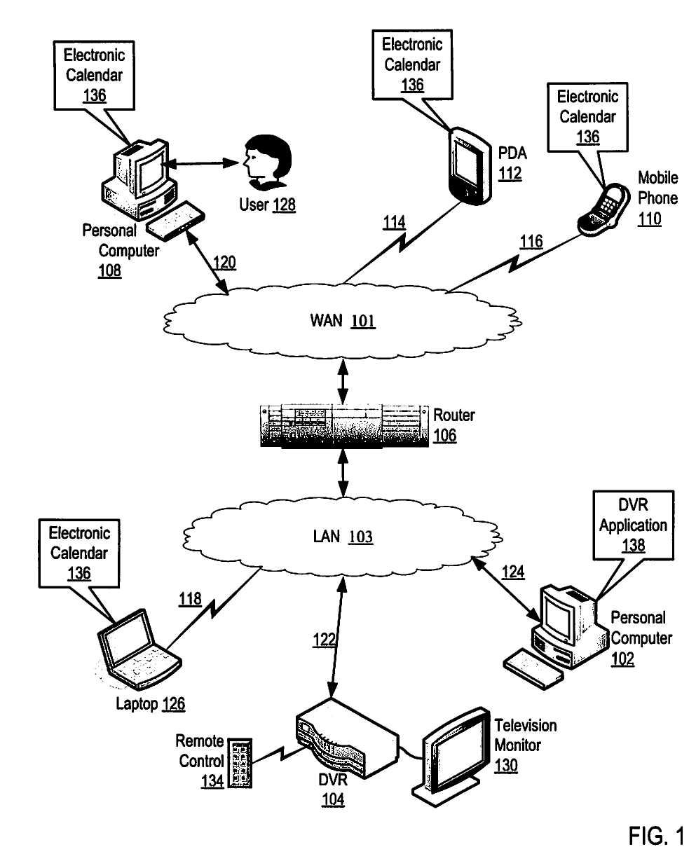

Exemplary methods, systems, and products for coordinating digital video recorder (‘DVR’) recording with a user's electronic calendar according to embodiments of the present invention are described with reference to the accompanying drawings, beginning with FIG. 1. FIG. 1 sets forth a network diagram illustrating an exemplary apparatus for coordinating DVR recording with a user's electronic calendar according to embodiments of the present invention. The example apparatus of FIG. 1 operates generally to coordinating DVR recording with a user's electronic calendar according to embodiments of the present invention by establishing, by the DVR on behalf of the user, a user profile on the DVR. The user profile includes a network location for the user's electronic calendar where the user's electronic calendar is installed upon a remote device, and the remote device is connected for data communications through a data communications network to the DVR. The DVR tracks information describing at least one show watched by the user, the DVR makes an electronic calendar entry on the user's electronic calendar in accordance with the information describing the show.

The apparatus of FIG. 1 includes a stand-alone set-top type of DVR (104) that is controlled by a remote control (134) and connected for viewing of recorded shows to a television monitor (130). The apparatus of FIG. 1 also includes a personal computer (102) implemented as a DVR with DRV application software (138). Both the DVR (104) and the personal computer (102) are connected for data communications to local area network (‘LAN’) (103) through wireline connections (122, 124).

A local area network (LAN) is a computer network covering a local area, like a home, office, or group of buildings. LANs in contrast to WANs (wide area networks) are defined by much higher data rates, smaller geographic range, and no requirement for leased telecommunication lines. LANs today are most commonly implemented with switched Ethernet at the physical layer and TCP/IP as a protocol, although there are many different options for physical, link, and protocol layers in LANs. In this example, the LAN is connected through a router (106) to a wide area network (‘WAN’) (101). A WAN is a computer network covering a broad geographical area. The most well-known example of a WAN is the Internet.

The apparatus of FIG. 1 includes several example remote devices (108, 112, 110, 126), each of which includes an electronic calendar (136). A ‘remote device’ as the term is used in this specification is ‘remote’ in the sense that the remote device is external to and separate from a DVR, so that the remote device and the DVR are connected for data communications through a data communications network. In addition, remote devices are automated, composed of automated computer machinery capable of operating an electronic calendar. An electronic calendar is a computer program that implements a calendar, including schedule entries or appointments, on automated computing machinery. The example remote devices in the apparatus of FIG. 1 include:
a personal computer (108) connected for data communications with the DVRs (104, 138) by a wireline connection (120) to WAN (101) and LAN (103),
a personal digital assistant (‘PDA’) (112) connected for data communications with the DVRs (104, 138) by a wireless connection (114) to WAN (101) and LAN (103),
a mobile telephone (110) connected for data communications with the DVRs (104, 138) by a wireless connection (116) to WAN (101) and LAN (103), and
a laptop computer (126) connected for data communications with the DVRs (104, 138) by a wireless connection (118) to LAN (103).

In the apparatus of FIG. 1, each DVR (104, 138) is configured so as to be capable of establishing on behalf of a user a user profile on the DVR. Each remote device (108, 112, 110, 126) bearing an electronic calendar (136) is connected for data communications through a data communication network (101, 103) to a DVR, and the user profile in each instance therefore includes a network location for the user's electronic calendar that identifies where in cyberspace the user's electronic calendar is installed upon a remote device. The network location may be implemented as a URL, a network address such as an Internet Protocol (‘IP’) address, a Media Access Control (‘MAC’) address, and in other ways as will occur to those of skill in the art. Each DVR (104, 138) records shows on behalf of one or more users, and the users eventually watch at least some of the shows. Each DVR tracks information describing shows watched by a user, and each DVR makes an electronic calendar entry on a user's electronic calendar in accordance with the information describing the shows.

The arrangement of DVRs, remote devices, and networks making up the exemplary apparatus illustrated in FIG. 1 are for explanation, not for limitation. Data processing systems useful for coordinating DVR recording with a user's electronic calendar according to various embodiments of the present invention may include additional servers, routers, other remote devices, and peer-to-peer architectures, not shown in FIG. 1, as will occur to those of skill in the art. Networks in such data processing systems may support many data communications protocols, including for example the Transmission Control Protocol (‘TCP’), the Internet Protocol (‘IP’), The HyperText Transfer Protocol (‘HTTP’), the Wireless Access Protocol (‘WAP’), the Handheld Device Transport Protocol (‘HDTP’), and others as will occur to those of skill in the art. Various embodiments of the present invention may be implemented on a variety of hardware platforms in addition to those illustrated in FIG. 1.

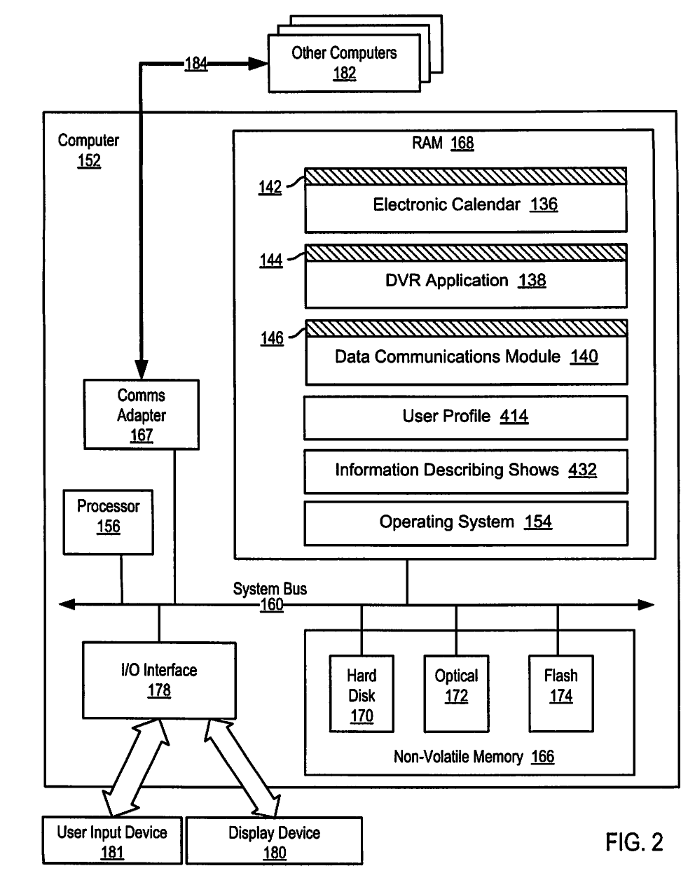

Coordinating DVR recording with a user's electronic calendar in accordance with the present invention is generally implemented with computers, that is, with automated computing machinery. In the system of FIG. 1, for example, all the remote devices, the DVRs, the router, and the networks are implemented to some extent at least as computers. For further explanation, therefore, FIG. 2 sets forth a block diagram of automated computing machinery comprising an exemplary computer (152) useful in coordinating DVR recording with a user's electronic calendar according to embodiments of the present invention. The computer of FIG. 2 is configured to function as a remote device with an electronic calendar, as a DVR, or as both a remote device and a DVR. The computer (152) of FIG. 2 includes at least one computer processor (156) or ‘CPU’ as well as random access memory (168) (“RAM”) which is connected through a system bus (160) to the processor (156) and to other components of the computer.

Stored in RAM (168) in the example computer (152) of FIG. 2 is an electronic calendar (136), a module of computer program instructions that provides time management tools for users. The electronic calendar (136) communicates with users through graphical user interface (‘GUI’) and exposes an application programming interface (‘API’) (142) through which a DVR may make electronic calendar entries on a user's electronic calendar according to information describing shows tracked on the DVR.

Also stored in RAM in this example is a DVR application (138), a module of computer program instructions that enable computer (152) to capture, record, and play back video from a hard drive (170). The term ‘DVR’ is used in this specification to refer to both stand-alone set-top box DVRs as well as DVRs implemented on general purpose computers with DVR application software that enables video capture and playback to and from disk. It is useful to note, however, that both kinds of DVRs are forms of automated computing machinery, and both kinds may operate with DVR application software.

In this example, the DVR application (138) is improved to coordinate DVR recording with a user's electronic calendar according to embodiments of the present invention establishing on behalf of a user a user profile (414) on a DVR. The user profile (414), shown here also in RAM, includes a network location for the user's electronic calendar where the user's electronic calendar is installed upon a remote device. The DVR application (138) tracks information (432) describing at least one show watched by the user, and the DVR application (138) makes an electronic calendar entry on a user's electronic calendar in accordance with the information describing the show or shows.

Also stored in RAM in this example is a data communications module (140), a module of computer program instructions for data communications between a DVR and an electronic calendar on a remote device. The data communications module enables data communications so that a DVR can make electronic calendar entries in an electronic calendar on a remote device connected to the DVR across a data communications network. The data communications module implements this data communications. A similar data communications module is provided for both remote devices and as well as DVRs. The data communications module exposes an API (146) through which a DVR application or an electronic calendar may send instructions to the data communications module. In this way, a DVR application may instruct the data communications module to communicate electronic calendar entries to an electronic calendar on a remote device. And an electronic device may use the API to instruct the data communications module to advise a DVR to delete a show from storage on the DVR when a user deletes from the electronic calendar an appointment to watch the show. The DVR application exposes an API (144) for use by the data communications module in communicating instructions from the electronic calendar to the DVR application.

Also stored in RAM (168) is an operating system (154). Operating systems useful in computers according to embodiments of the present invention include UNIX™, Linux™, Microsoft Windows™, AIX™, IBM's i5/OS™, and others as will occur to those of skill in the art. The operating system (154), the electronic calendar (136), the DVR application (138), the data communications module (140), the user profile (414), and the information describing shows (432) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out through serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for coordinating DVR recording with a user's electronic calendar according to embodiments of the present invention include modems for wired dial-up communications, Ethernet (IEEE 802.3) adapters for wired network communications, and 802.11b adapters for wireless network communications.

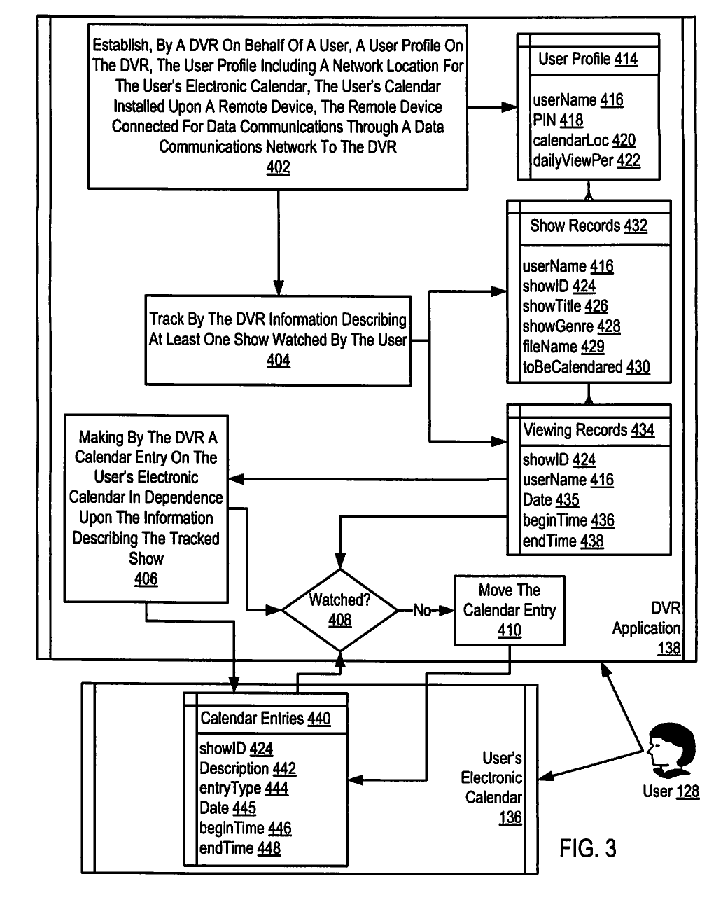

For further explanation, FIG. 3 sets forth a flow chart illustrating an exemplary method of coordinating DVR recording with a user's electronic calendar according to embodiments of the present invention. The method of FIG. 3 includes establishing (402), by the DVR on behalf of a user (128), a user profile (414) on the DVR. In this example, the DVR is represented by DVR application (138), which may a DVR application on a stand-alone set-top DVR or a DVR application on a general purpose computer such as a personal computer. The user profile (414) in this example is represented as a data structure that includes storage for the identification code, such as a user name, in a field named “userName” (416), a personal identification number for the user in a field named “PIN” (418), a network location (420) for the user's electronic calendar in a field named “electronic calendarLoc” (136), and an indication of the user's typical daily viewing period in a field named “dailyViewPer” (422). The user's electronic calendar is installed upon a remote device of the kind described above with reference to FIG. 1, and the remote device is connected for data communications to the DVR through a data communications network as described above with reference to FIG. 1.

The method of FIG. 3 also includes tracking (404) by the DVR information describing at least one show watched by the user. Information describing at least one show watched by the user in this example is tracked by use of a data structure named “Show Records” (432) which may be implemented as a table, for example, in which each record represents a show recorded on the DVR for the user. Each Show Record includes storage for the user's identification (416) which here is used a foreign key to the user profile (414, 416), relating the show records to the user profile many-to-one. Each Show Record also includes storage for a show identification code in a field named showID (424), storage for a show's title in a field named “showTitle” (426), storage for a show's genre in a field named “showGenre” (428), storage for the name of the file in which the show is stored in non-volatile storage on the DVR in a field named “fileName” (429), and a Boolean indication of whether the show is to be electronic calendared in a field named “toBeCalendared” (430).

Information describing at least one show watched by the user in this example is tracked by use of a data structure named “Viewing Records” (434), which also may be implemented, for example, as a table in which each record represents a viewing of a show by a user. A user may view a show more than once, so Viewing Records (434) are related many-to-one to Show Records (432) by the foreign key “showID” (424). More than one user may view a show, so the Viewing Records include storage for user identifiers in the field “userName” (416). Viewing Records also include storage indicating, for each viewing of a show by a user, the date (435) of each viewing, the time when the viewing began in a field named “beginTime” (436) and the time when the viewing ended in a field named “endTime” (438).

The method of FIG. 3 also includes making (406) by the DVR an electronic calendar entry (440) on the user's electronic calendar (136) in dependence upon the information describing the show. That is, the DVR uses the tracked information describing the show from the Show Records and the Viewing Records to formulate an electronic calendar entry for the user's electronic calendar. In this example, electronic calendar entries are represented by a data structure named “Electronic calendar Entries” (440) that may be implemented as a table, for example, in which each record represents an electronic calendar entry in a user's electronic calendar (136). Each such electronic calendar entry includes storage for a show identification code in a field named “showID” (424) and storage for a text string describing the electronic calendar entry in a field named “Description” (442). Each Electronic calendar Entry record also includes storage for an electronic calendar entry type code in the field named “entryType” (444); the entryType field is used to indicate to the user's electronic calendar the electronic calendar entries that are made by the DVR, to distinguish them as needed from electronic calendar entries from other sources such as, for example, electronic calendar entries made by the user through a GUI, mouseclicks, or keyboard input. The electronic calendar entries made by the DVR are typically in effect ‘appointments’ with a show to be viewed by the user, so each of the Electronic calendar Entries (440) in this example also includes a date field (445), a beginning time for each electronic calendar entry in a field named “beginTime” (446), and a ending time for each electronic calendar entry in a field named “endTime” (448).

In the method of FIG. 3, tracking (404) information (432, 434) describing the show may be carried out by tracking a time (436) when the user typically begins watching the show, and making (406) an electronic calendar entry (440) may be carried out by making an electronic calendar entry having a beginning time (446) equal to the tracked time when the user typically begins watching the show. Consider an example of a user who has instructed the DVR to record “CSI Miami” weekly. The DVR tracks the time when the user begins watching “CSI Miami” in beginTime (436) in the Viewing Records (434) for “CSI Miami.” The DVR then tracks a time when the user typically begins watching “CSI Miami” by averaging the last five values of beginTime (436). “CSI Miami” is weekly broadcast at 7:00 p.m. local time, but the DVR tracks the user's typical time to begin watching as 7:15 p.m., thereby enabling the DVR's ability to skip advertising. The DVR therefore makes an electronic calendar entry (440) having a beginning time (446) of 7:15 p.m. When the user checks the user's electronic calendar during the user's work day, the user will see a reminder, an appointment as it were, to watch “CSI Miami” at 7:15 p.m.

In the method of FIG. 3, tracking (404) information (432, 434) describing the show also may be carried out by tracking the amount of time required for the user to watch the show, and making an electronic calendar entry may be carried out by making an electronic calendar entry having a duration equal to the tracked amount of time required for the user to watch the show. Continuing the example of a user who has instructed the DVR to record “CSI Miami” weekly: The DVR tracks the time when the user begins watching “CSI Miami” in beginTime (436) in the Viewing Records (434) for “CSI Miami” and also tracks the time when the user finishes watching in endTime (438). The DVR then tracks the amount of time required for the user to watch the show by averaging the last five values of beginTime (436) and the last five values of endTime (438) and subtracting those values. “CSI Miami” is an hour-long show, but the DVR tracks the amount of time required for the user to watch the show as 45 minutes, true because the user makes good use of the DVR's ability to skip advertising. The DVR therefore makes an electronic calendar entry (440) having a beginning time (446) of 7:15 p.m. and an ending time (448) of 8:00 p.m. When the user checks the user's electronic calendar during the user's work day, the user will see 45 minutes scheduled beginning at 7:15 p.m. for watching “CSI Miami.”

In the method of FIG. 3, the user profile (414) may include information (422) indicating a daily viewing period for the user, and making (406) an electronic calendar entry (440) may be carried out by making an electronic calendar entry only for viewing a show during the user's indicated daily viewing period. The daily viewing period may be entered in the user's profile directly by the user through a user interface on the DVR, or the daily viewing period may be inferred by the DVR application (138) by use of the beginning times (436) and ending times (438) in the viewing records (434). If there are no beginning times (436) prior to 8:00 p.m. and no ending times after 11:00 p.m., the DVR can infer that the user's daily viewing period is from 8:00 p.m. to 11:00 p.m., for example, after the children are in bed.

In the method of FIG. 3, tracking (404) information (432, 434) describing at least one show may be carried out by the DVR's tracking information from the user identifying shows for which electronic calendar entries are to be made by the DVR, and making (406) an electronic calendar entry (440) may be carried out by making an electronic calendar entry only for a show identified by the user as a show for which electronic calendar entries are to be made by the DVR. In the example of FIG. 3, the information identifying shows for which electronic calendar entries are to be made is recorded in the Boolean field “toBeCalendared” (430) in the show records (432), related to the user profile through the foreign key userName (416). A value of TRUE in toBeCalendared (430) identifies a show for which electronic calendar entries are to be made. The user may watch many shows that are not important enough to the user for the user to want to see electronic calendar entries for them. The user may watch so much television that electronic calendaring all the shows the user watches may clutter up the user's electronic calendar. The toBeCalendared field allows the user to have electronic calendar entries only for the user's favorite shows, for example.

In the method of FIG. 3, the method may includes determining (408) whether the user watches a show for which an electronic calendar entry has been made, and, if the user does not watch the show in accordance with the electronic calendar entry for the show, moving (410) the electronic calendar entry. Determining (408) whether the user watches a show for which an electronic calendar entry has been made may be carried out by comparing the values of the date (445), beginTime (446), and endTime (448) fields of the electronic calendar entry (440) for the show with the values of the date (435), beginTime (436), and endTime (438) fields in the viewing records (434) for the show. If the viewing records show that the show has not been watched by the scheduled date and time for watching the show as shown in the electronic calendar entries, then the DVR may move the electronic calendar entry to a later date or time. Moving the electronic calendar entry is carried out by sending from the DVR to the electronic calendar by a data communications protocol message on a data communications network an instruction to move the electronic calendar entry to a new date or time. Moving the electronic calendar entry may be carried out in the electronic calendar by updating the date (445) field and or the beginTime (446) and endTime (448) fields for the electronic calendar entry for the show; the electronic calendar entry already exists, so the only need now is to update its date or time in order to effectively move the electronic calendar entry.

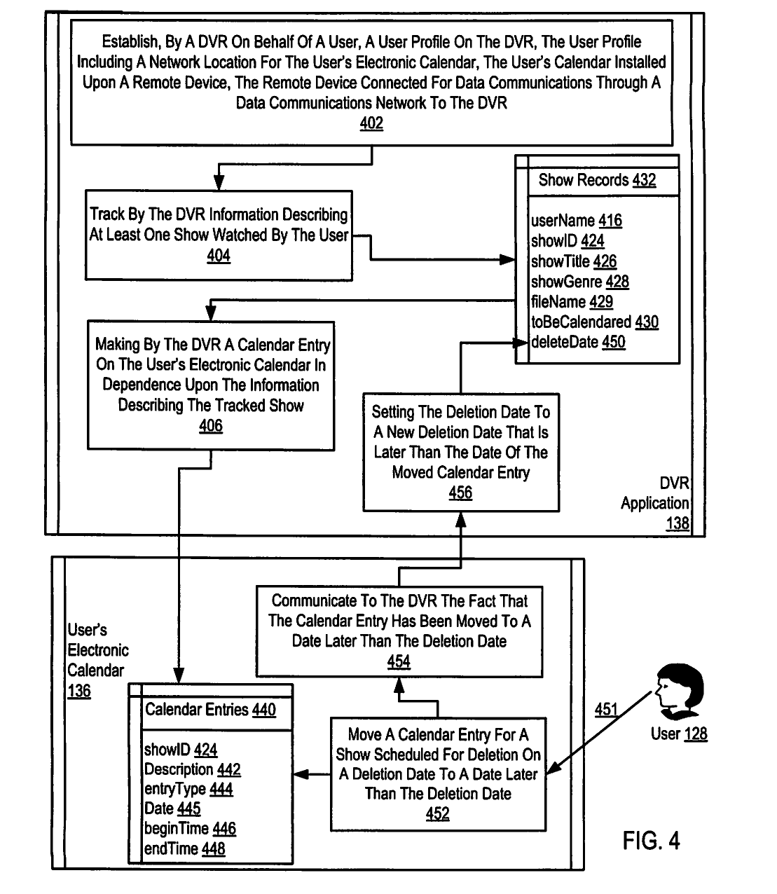

For further explanation, FIG. 4 sets forth a flow chart illustrating a further exemplary method for coordinating DVR recording with a user's electronic calendar according to embodiments of the present invention. Like the method of FIG. 3, the method of FIG. 4 includes establishing (402) a user profile on a DVR, the DVR's tracking (404) information describing at least one show watched by the user, and the DVR's making (406) an electronic calendar entry on the user's electronic calendar in dependence upon the information describing the show. The method of FIG. 4 also includes moving (452), by the electronic calendar responsive to a user instruction (451), an electronic calendar entry (440) for a show (432) scheduled for deletion on a deletion date (450) to a date later than the deletion date. The user instruction (451) is received from the user (128) in the electronic calendar through a GUI, mouseclicks, keyboard entry, or the like. The method of FIG. 4 also includes the electronic calendar's communicating (454) to the DVR the fact that the electronic calendar entry has been moved to a date later than the deletion date. Communicating this fact to the DVR is carried out by sending from the DVR to the electronic calendar by a data communications protocol message on a data communications network information regarding the new date of the electronic calendar entry.

The user's electronic calendar may not necessarily track deletion dates, so the communication of the fact that the new electronic calendar date is later than the deletion date may be in the new date itself. The DVR may compare the new date to the deletion date and determine that the new date is later than the deletion date. Either way, in this example, the method of FIG. 4 also includes the DVR's setting (456) the deletion date (450) to a new deletion date that is later than the date of the moved electronic calendar entry. The fact that the user moved the electronic calendar date indicates that the user wishes to view the show on the new date. The DVR extends the deletion date so that the show will still be available on the DVR on the new electronic calendar date.

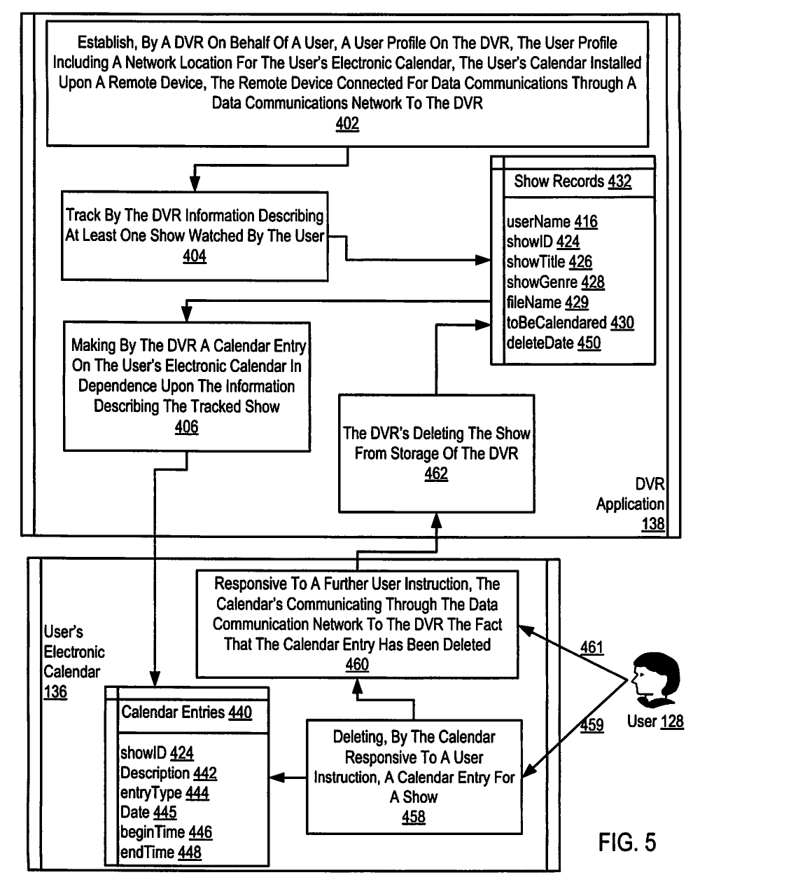

For further explanation, FIG. 5 sets forth a flow chart illustrating a further exemplary method for coordinating DVR recording with a user's electronic calendar according to embodiments of the present invention. Like the method of FIG. 3, the method of FIG. 5 includes establishing (402) a user profile on a DVR, the DVR's tracking (404) information describing at least one show watched by the user, and the DVR's making (406) an electronic calendar entry on the user's electronic calendar in dependence upon the information describing the show. The method of FIG. 5 also includes deleting (458), by the electronic calendar (136) responsive to a user instruction (459), an electronic calendar entry (440) for a show. The user instruction (459) is received from the user (128) in the electronic calendar through a GUI, mouseclicks, keyboard entry, or the like. The user instruction (459) is an instruction to delete the electronic calendar entry.

The method of FIG. 5 also includes the electronic calendar's (136) communicating (360), responsive to a further user instruction (461), to the DVR the fact that the electronic calendar entry has been deleted. The instruction to delete the calendar entry is taken as an indication that the user may not want to watch the show and so therefore also may wish to delete the show from the DVR. The further user instruction is received in the electronic calendar through a GUI, mouseclicks, keyboard input, or the like, from the user (128) in response to a prompt from the electronic calendar asking the user whether the user wishes to delete the show from the DVR. If the user indicates that the show on the DVR is to be deleted, then the electronic calendar communicates to the DVR the fact that the electronic calendar entry has been deleted, effectively advising the DVR to delete the show from storage on the DVR. Communicating this fact to the DVR is carried out by sending from the DVR to the electronic calendar by a data communications protocol message on a data communications network information notice of the deletion. The message to the DVR can include the showID (424) from the calendar entry (440), so that the DVR can be advised exactly which show had its calendar entry deleted and exactly which show to delete from storage on the DVR. The method of FIG. 5 also includes the DVR's deleting the show from storage of the DVR.

Exemplary embodiments of the present invention are described largely in the context of a fully functional computer system for coordinating DVR recording with a user's electronic calendar. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of coordinating digital video recorder (‘DVR’) recording with a user's electronic calendar, the method comprising:
establishing, by the DVR on behalf of the user, a user profile on the DVR, the user profile including a network location for the user's electronic calendar, the user's electronic calendar installed upon a remote device, the remote device connected for data communications through a data communications network to the DVR;
tracking by the DVR information describing at least one show watched by the user; and
making by the DVR an electronic calendar entry on the user's electronic calendar in dependence upon the information describing the show.

2. The method of claim 1 wherein:
tracking information describing the show further comprises tracking a time when the user typically begins watching the show; and
making an electronic calendar entry further comprises making an electronic calendar entry having a beginning time equal to the tracked time when the user typically begins watching the show.

3. The method of claim 1 wherein:
tracking information describing the show further comprises tracking the amount of time required for the user to watch the show; and
making an electronic calendar entry further comprises making an electronic calendar entry having a duration equal to the tracked amount of time required for the user to watch the show.

4. The method of claim 1 wherein:
the user profile further comprises information indicating a daily viewing period for the user; and
making an electronic calendar entry further comprises making an electronic calendar entry only for viewing a show during the user's indicated daily viewing period.

5. The method of claim 1 wherein:
tracking information describing at least one show further comprises tracking by the DVR information from the user identifying shows for which electronic calendar entries are to be made by the DVR; and
making an electronic calendar entry further comprises making an electronic calendar entry only for a show identified by the user as a show for which electronic calendar entries are to be made by the DVR.

6. The method of claim 1 wherein:
the method further comprises determining whether the user watches a show for which an electronic calendar entry has been made; and
if the user does not watch the show in accordance with the electronic calendar entry for the show, moving the electronic calendar entry.

7. The method of claim 1 further comprising:
moving, by the electronic calendar responsive to a user instruction, an electronic calendar entry for a show scheduled for deletion on a deletion date to a date later than the deletion date;
the electronic calendar's communicating through the data communication network to the DVR the fact that the electronic calendar entry has been moved to a date later than the deletion date; and
the DVR's setting the deletion date to a new deletion date that is later than the date of the moved electronic calendar entry.

8. The method of claim 1 further comprising:
deleting, by the electronic calendar responsive to a user instruction, an electronic calendar entry for a show;
responsive to a further user instruction, the electronic calendar's communicating through the data communication network to the DVR the fact that the electronic calendar entry has been deleted; and
the DVR's deleting the show from storage of the DVR.

9. Apparatus for coordinating digital video recorder (‘DVR’) recording with a user's electronic calendar, the apparatus comprising at least one computer processor and at least one computer memory operatively coupled to the computer processor, the computer memory having disposed within it computer program instructions capable of:
establishing, by the DVR on behalf of the user, a user profile on the DVR, the user profile including a network location for the user's electronic calendar, the user's electronic calendar installed upon a remote device, the remote device connected for data communications through a data communications network to the DVR;
tracking by the DVR information describing at least one show watched by the user; and
making by the DVR an electronic calendar entry on the user's electronic calendar in dependence upon the information describing the show.

10. The apparatus of claim 8 wherein:
tracking information describing the show further comprises tracking a time when the user typically begins watching the show; and
making an electronic calendar entry further comprises making an electronic calendar entry having a beginning time equal to the tracked time when the user typically begins watching the show.

11. The apparatus of claim 8 wherein:
tracking information describing the show further comprises tracking the amount of time required for the user to watch the show; and
making an electronic calendar entry further comprises making an electronic calendar entry having a duration equal to the tracked amount of time required for the user to watch the show.

12. The apparatus of claim 8 wherein:
the user profile further comprises information indicating a daily viewing period for the user; and
making an electronic calendar entry further comprises making an electronic calendar entry only for viewing a show during the user's indicated daily viewing period.

13. The apparatus of claim 8 wherein:
tracking information describing at least one show further comprises tracking by the DVR information from the user identifying shows for which electronic calendar entries are to be made by the DVR; and
making an electronic calendar entry further comprises making an electronic calendar entry only for a show identified by the user as a show for which electronic calendar entries are to be made by the DVR.

14. A computer program product for coordinating digital video recorder (‘DVR’) recording with a user's electronic calendar, the computer program product disposed upon a signal bearing medium, the computer program product comprising computer program instructions capable of:
establishing, by the DVR on behalf of the user, a user profile on the DVR, the user profile including a network location for the user's electronic calendar, the user's electronic calendar installed upon a remote device, the remote device connected for data communications through a data communications network to the DVR;
tracking by the DVR information describing at least one show watched by the user; and
making by the DVR an electronic calendar entry on the user's electronic calendar in dependence upon the information describing the show.

15. The computer program product of claim 14 wherein the signal bearing medium comprises a recordable medium.

16. The computer program product of claim 14 wherein the signal bearing medium comprises a transmission medium.

17. The method of claim 1 wherein:
tracking information describing the show further comprises tracking a time when the user typically begins watching the show; and
making an electronic calendar entry further comprises making an electronic calendar entry having a beginning time equal to the tracked time when the user typically begins watching the show.

18. The method of claim 1 wherein:
tracking information describing the show further comprises tracking the amount of time required for the user to watch the show; and
making an electronic calendar entry further comprises making an electronic calendar entry having a duration equal to the tracked amount of time required for the user to watch the show.

19. The method of claim 1 wherein:
the user profile further comprises information indicating a daily viewing period for the user; and
making an electronic calendar entry further comprises making an electronic calendar entry only for viewing a show during the user's indicated daily viewing period.

20. The method of claim 1 wherein:
tracking information describing at least one show further comprises tracking by the DVR information from the user identifying shows for which electronic calendar entries are to be made by the DVR; and
making an electronic calendar entry further comprises making an electronic calendar entry only for a show identified by the user as a show for which electronic calendar entries are to be made by the DVR.
